(19) United States
(12) Patent Application Publication
(10) Pub. No.: US 2026/0095278 A1
(43) Pub. Date: Apr. 2, 2026

(54) SCHEDULING RADIO RESOURCES FOR A CARRIER GROUP BY MULTIPLE DISTRIBUTED UNITS

(71) Applicant: Rakuten Symphony, Inc., Tokyo (JP)

(72) Inventors: Sridhar BHASKARAN, Karnataka (IN); Prasanna DESIKAN, Karnataka (IN); Nirav SALOT, Karnataka (IN)

(73) Assignee: Rakuten Symphony, Inc., Tokyo (JP)

(21) Appl. No.: 19/257,559

(22) Filed: Jul. 2, 2025

(30) Foreign Application Priority Data
Sep. 27, 2024 (IN) 202411073157

(51) Int. Cl. H04L 5/00; H04W 72/0446

(52) U.S. Cl. CPC H04L 5/0005; H04W 72/0446

(57) ABSTRACT

Disclosed herein is an apparatus (114) configured to obtain a number of Physical Resource Blocks (PRBs) corresponding to each of one or more DUs. The one or more DUs are associated with carrier aggregation for a carrier group. Further, the apparatus (114) is configured to identify a leader DU, from among the one or more DUs, based on the obtained number of PRBs associated with each of the one or more DUs. Further, the apparatus (114) is configured to assign a corresponding sequence identifier (ID) to each of the one or more DUs based on the obtained number of PRBs. Further, the apparatus (114) is configured to receive a set of tokens from the identified leader DU. Furthermore, the apparatus (114) is configured to perform a data transmission for the carrier group, based on the received set of tokens.

### CROSS-REFERENCE TO RELATED APPLICATION(S)

This application claims priority to Indian non-provisional patent application 202411073157, filed on Sep. 27, 2024, the entire contents of which are incorporated herein by reference.

### TECHNICAL FIELD

The present disclosure relates to scheduling radio resources for a carrier group by multiple Distributed Units (DUs).

### BACKGROUND

The information disclosed in this background section is only for the enhancement of understanding of the general background of the disclosure and should not be taken as an acknowledgement or any form of suggestion that this information forms the prior art already known to a person skilled in the art.

In wireless communication systems, the Distributed Unit (DU) is usually responsible for managing radio resources for multiple carriers (or cells) in a carrier group. The fronthaul link capacity between the DU and the Radio Unit (RU) limits the data packets transmitted by the carriers in a time slot. The fronthaul link capacity is dependent on the capacity of the optical fibers and the links present between the DU and the RU. Further, upgrading the fronthaul link capacity is costly for a network operator.

The conventional techniques are unable to efficiently schedule radio resources among the multiple carriers without exceeding the shared fronthaul link capacity. Further, in a scenario where the one or more carriers in a carrier group are spread across multiple DUs, coordination among the DUs is very important. In the existing techniques, there is an absence of a mechanism to ensure coordination among the DUs associated with a carrier group.

Thus, there is a need to provide a methodology to overcome the above-mentioned issues in the conventional techniques.

### SUMMARY

This summary is provided to introduce a selection of concepts, in a simplified format, that are further described in the detailed description of the disclosure. This summary is neither intended to identify key or essential inventive concepts of the disclosure nor is it intended to determine the scope of the disclosure.

According to one embodiment of the present disclosure, an apparatus is disclosed. The apparatus is configured to obtain a number of Physical Resource Blocks (PRBs) corresponding to each of one or more DUs. The one or more DUs are associated with carrier aggregation for a carrier group. Further, the apparatus is configured to identify a leader DU, from among the one or more DUs. The leader DU is identified based on the obtained number of PRBs associated with each of the one or more DUs. Further, the apparatus is configured to assign a corresponding sequence identifier (ID) to each of the one or more DUs based on the obtained number of PRBs. Further, the apparatus is configured to receive a set of tokens from the identified leader DU. Furthermore, the apparatus is configured to perform a data transmission for the carrier group, based on the received set of tokens.

According to one embodiment of the present disclosure, a method is disclosed. The method includes obtaining a number of Physical Resource Blocks (PRBs) corresponding to each of one or more DUs. The one or more DUs are associated with carrier aggregation for a carrier group. Further, the method includes identifying a leader DU, from among the one or more DUs. The leader DU is identified based on the obtained number of PRBs associated with each of the one or more DUs. Further, the method includes assigning a corresponding sequence identifier (ID) to each of the one or more DUs based on the obtained number of PRBs. Further, the method includes receiving a set of tokens from the identified leader DU. Furthermore, the method includes performing a data transmission for the carrier group, based on the received set of tokens.

According to another embodiment of the present disclosure, a non-transitory computer-readable medium is disclosed. The non-transitory computer-readable medium stores instructions. The instructions comprise one or more instructions that are executed by a Distributed Unit (DU). The DU comprises one or more processors. The one or more instructions cause the one or more processors to obtain a number of Physical Resource Blocks (PRBs) corresponding to each of one or more DUs. The one or more DUs are associated with carrier aggregation for a carrier group. Further, the one or more instructions cause the one or more processors to identify a leader DU, from among the one or more DUs. The leader DU is identified based on the obtained number of PRBs associated with each of the one or more DUs. Further, the one or more instructions cause the one or more processors to assign a corresponding sequence identifier (ID) to each of the one or more DUs based on the obtained number of PRBs. Further, the one or more instructions cause the one or more processors to receive a set of tokens from the identified leader DU. Furthermore, the one or more instructions cause the one or more processors to perform a data transmission for the carrier group, based on the received set of tokens.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF FIGURES

Features, aspects, and advantages of certain example embodiments of the disclosure will be described below with reference to the accompanying drawings, in which like reference numerals denote like elements, and wherein:

FIG. 1 illustrates an example block diagram of a communication environment depicting an Open Radio Access Network (O-RAN) architecture, in accordance with an embodiment of the present disclosure;

FIGS. 2A-2C illustrate examples of fronthaul deployment topologies, in accordance with an embodiment of the present disclosure;

FIG. 3 illustrates the mapping of one or more carriers to shared fronthaul link capacity, in accordance with an embodiment of the present disclosure;

FIG. 4 illustrates scheduling the transmission of data packets for one or more carriers via a shared buffer, in accordance with an embodiment of the present disclosure;

FIG. 5 illustrates a process flow depicting a method for implementing radio resource scheduling for a carrier group by one or more DUs, in accordance with an embodiment of the present disclosure; and

FIG. 6 illustrates an embodiment of a device, in accordance with an embodiment of the present disclosure.

### DETAILED DESCRIPTION

The following detailed description of example embodiments refers to the accompanying drawings. The foregoing disclosure provides illustration and description but is not intended to be exhaustive or to limit the implementations to the precise form disclosed. Modifications and variations are possible in light of the above disclosure or may be acquired from the practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched, as long as these modifications may not affect the resulting scope of the invention.

It will be apparent that systems and/or methods, described herein, may be implemented in different forms of hardware, software, or a combination of hardware and software. The actual specialized control hardware or software code used to implement these systems and/or methods is not limiting to the implementations. Thus, the operation and behaviour of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from the practice of the implementations.

The disclosed apparatus and method enable the grouping of one or more carriers sharing a fronthaul link. The present disclosure allows scheduling the data packets to be transmitted for one or more carriers forming a configured carrier group. The transmission is scheduled based on the configured capacity of the shared fronthaul link. The present disclosure enables scheduling the transmission for the carrier group by multiple Distributed Units (DUs). The one or more carriers of the of the carrier group are associated with one or more DUs present at different sites. The present disclosure allows coordination among the one or more DUs to schedule the transmission based on the capacity of the shared fronthaul link. The transmission for the carrier group is scheduled to ensure that the data packets to be transmitted at each time slot do not exceed the configured capacity of the shared fronthaul link.

Now example embodiments of the present disclosure will be described below in detail with reference to the accompanying drawings.

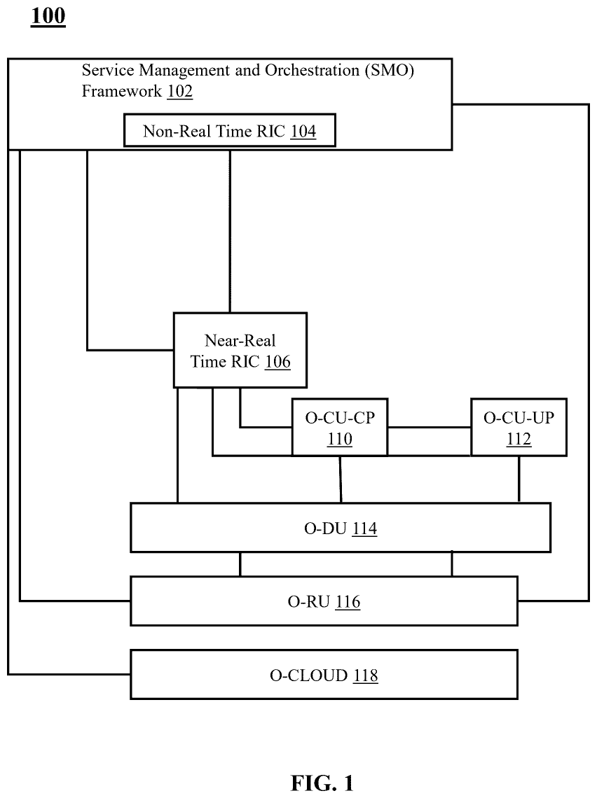

FIG. 1 illustrates an example block diagram of a communication environment depicting an Open Radio Access Network (O-RAN) architecture 100, in accordance with an embodiment of the present disclosure. The architecture illustrated is provided as an example and is non-limiting to the scope of the present disclosure. In various embodiments of the present disclosure, the apparatus corresponds to a DU, from among the one or more DUs, in a communication network.

In FIG. 1, a Service Management and Orchestration Framework (SMO) 102 provides data services to the network functions. The SMO 102 allows managed network functions to interoperate and communicate within the O-RAN. The SMO 102 connects to and manages RAN Intelligent Controllers (RICs) 104 and 106, an O-Cloud 118, an O-RAN Central Unit (0-CU), and an O-RAN Distributed Unit (O-DU) 114.

The RICs may include a non-real-time RIC 104 and near-real-time RIC 106. The RICs are logical functions for controlling and optimizing the elements and resources of an O-RAN.

A near-real-time RIC 106 controls and optimizes elements and resources with granular data collection. The interfaces connecting the different components of the O-RAN architecture are not illustrated for the sake of clarity.

The O-Cloud 118 is a cloud computing platform made up of the physical infrastructure nodes using the O-RAN architecture. The O-Cloud 118 creates and hosts various virtual network functions (VNFs) used by the RICs and other infrastructure elements.

The O-CU is a logical node that hosts network protocols such as the radio resource control (RRC), service data adaptation protocol (SDAP), and packet data convergence protocol (PDCP). The O-CU may be further disaggregated into an O-CU-CP 110 corresponds to the O-RAN control unit for the control plane, and an O-CU-UP 112 corresponds to the O-RAN control unit for the user plane.

The O-DU 114 (also referred to as DU 114) is a logical node that hosts network protocols such as the radio link control (RLC) protocol, medium access control (MAC) protocol, and the physical interface (PHY). FIG. 1 illustrates a single O-DU 114 as a non-limiting example, and the network may include multiple O-DUs. A single O-DU 114 is depicted for the sake of clarity. Further, in scenarios with multiple DUs, the DUs are configured to communicate with one another using sidehaul links.

The O-RAN Radio Unit (O-RU) 116 (also referred to as RU 116) processes radio frequencies received by the physical layer of the network. The processed radio frequencies are sent to the O-DU 114 through a front-haul interface.

The present disclosure in some of the non-limiting embodiments illustrates the SMO 102 as the network entity controlling the DU 114. The functions of the SMO 102 may be performed by another Core Network (CN) entity in some embodiments as obvious to a person skilled in the art.

As used in the present disclosure, the term “carrier” refers to a single frequency band or a subset of frequency bands used for transmitting and receiving data. The data may be transmitted and received between a base station and a User Equipment (UE) in a wireless communication system. Each carrier is usually associated with a frequency band, a bandwidth, a modulation scheme, and a coding scheme. The terms “carrier” and “cell” are used interchangeably in the present disclosure.

As used in the present disclosure, the term “carrier aggregation” refers to a technique where multiple carriers are combined and utilized simultaneously. The carrier aggregation is usually performed to increase overall bandwidth, improve data rates, and enhance network capacity.

As used in the present disclosure, the term “carrier group” refers to multiple carriers grouped to implement carrier aggregation. The carriers in a carrier group may share common radio resources. The carriers in a carrier group may be managed by a single DU or multiple DUs.

As used in the present disclosure, the Physical resource blocks (PRBs) correspond to the smallest unit of resource allocation in the frequency domain in a wireless communication system. The resource allocation is associated with scheduling the transmission of data packets for a carrier group. The PRBs may be used for transmitting data packets, control signalling, and reference signals. In an example, a PRB may consist of 12 subcarriers (180 KHz) in the frequency domain. Further, a Transmission Time Interval (TTI) may correspond, but not limited to, 0.125 ms or 0.25 ms or or 0.5 ms or 1 ms in the time domain depending on the sub-carrier spacing (120 KHz or 60 KHz or 30 KHz or 15 KHz respectively)

As used in the present disclosure, the Resource Blocks (RBs) correspond to a logical grouping of PRBs across the one or more carriers in a carrier group.

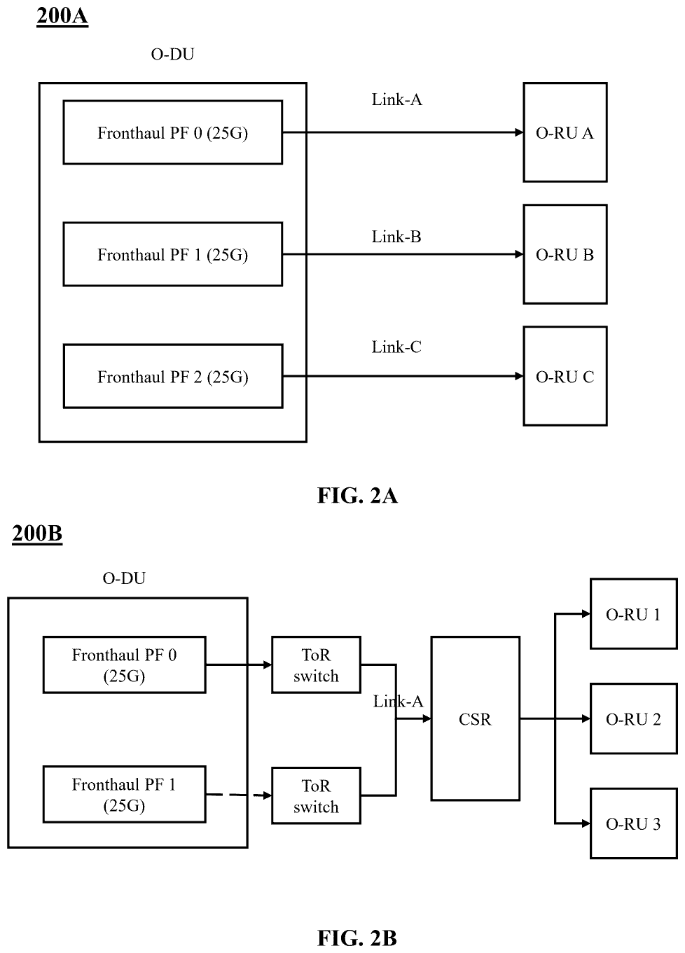

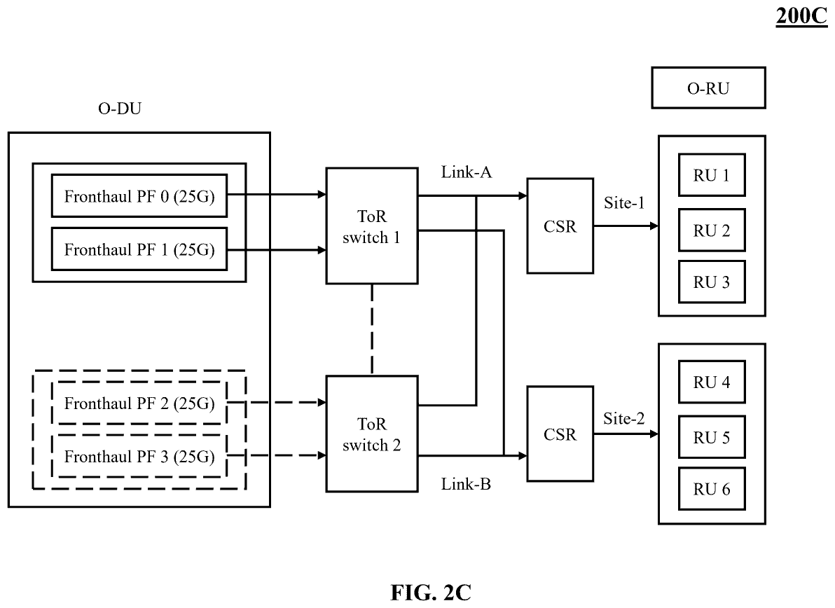

FIGS. 2A-2C illustrate examples of fronthaul deployment topologies, in accordance with an embodiment of the present disclosure.

FIG. 2A illustrates a point-to-point connection between an O-DU 114 and O-RU 116.

As illustrated in FIG. 2A, the O-DU 114 is depicted with three physical ports with fronthaul capacity of 25 Gbps. The three physical ports are depicted as Fronthaul PF 0, Fronthaul PF 1, and Fronthaul PF 2. Further, three O-RUs 116 are depicted as O-RU A, O-RU B, and O-RU C. In the topology, the O-DU 114 is connected via point-to-point connection to each O-RU 116 at a cell site. For instance, the port Fronthaul PF 0 of the O-DU 114 is connected to the O-RU 116 via a dedicated fronthaul link depicted as Link A. The link capacity towards each O-RU 116 is not shared with other O-RU 116. Further, dedicated links depicted as Link A, Link B, and Link C are used for the point-to-point connection. Further, each O-RU 116 supports one or more carriers (or cells in a network).

FIG. 2B illustrates an O-DU 114 connected to multiple O-RUs 116. The O-RUs 116 are present at a cell site and are connected to the O-DU 114 through a fronthaul switched network.

As illustrated in FIG. 2B, the O-DU 114 is illustrated with two physical ports as Fronthaul PF 0, Fronthaul PF 1 in active mode or standby mode. In FIG. 2B, the physical port Fronthaul PF 0 is in the active mode and the physical port Fronthaul PF 1 is in the standby mode. FIG. 2B illustrates three O-RUs as O-RU 1, O-RU 2, and O-RU 3.

In the topology, the O-DU 114 is connected to the O-RUs 116 at a cell site through a fronthaul switched network. As illustrated, the fronthaul switched network may contain Top of Rack (ToR) switches at a data center where O-DU 114 is deployed. Further, the fronthaul switched network may contain Cell Site Routers (CSR) at the cell site. The three O-RUs at the cell site are illustrated to share the fronthaul capacity of Link A of the O-DU 114. Further, each O-RU 116 supports one or more carriers (or cells in a network).

FIG. 2C illustrates an O-DU 114 connected to multiple O-RUs 116. The O-RUs 116 are present across two cell sites. The O-RUs 116 are connected to the O-DU 114 through a fronthaul switched network.

As illustrated in FIG. 2C, the O-DU 114 is illustrated with two physical port groups.

A first physical port group is in active mode and is depicted to include physical ports Fronthaul PF 0 and Fronthaul PF 1. A second physical port group is in standby mode and is depicted to include physical ports Fronthaul PF 1 and Fronthaul PF 2. In FIG. 2C, three O-RUs are depicted at site-1 and three O-RUs are depicted at site-2.

One of the physical ports of the first physical port group (in the active mode) carries all the fronthaul traffic (or data packets) to be transmitted to the O-RUs in site-1. Further, the other physical port of the first physical port group carries all the fronthaul traffic to be transmitted to O-RUs in site-2. Thus, the O-RUs at a cell site share the fronthaul capacity for all links from O-DU 114 towards each cell site.

In the topology, the O-DU 114 is connected to the O-RUs 116 across two cell sites (depicted as site-1 and site-2) through a fronthaul switched network. As illustrated, the fronthaul switched network may contain Top of Rack (ToR) switches (ToR switch 1 and ToR switch 2) at the data center where O-DU 114 is deployed. Further, the fronthaul switched network may contain Cell Site Routers (CSR) at each cell site.

In the topologies illustrated in FIGS. 2A-2C, the fronthaul capacity of the physical ports is depicted as 25 Gbps as a non-limiting example. In some scenarios, the fronthaul capacity of the physical ports may be configured as 10 Gbps. The fronthaul capacity of the physical ports depends on the carrier bandwidth required to be served across O-RUs 116 at a cell site (e.g. site-1).

FIGS. 2A-2C illustrate fronthaul deployment topologies with a single DU 114 for the sake of clarity. The fronthaul deployment topologies may include one or more DUs. Further, the one or more DUs may communicate with each other using sidehaul links.

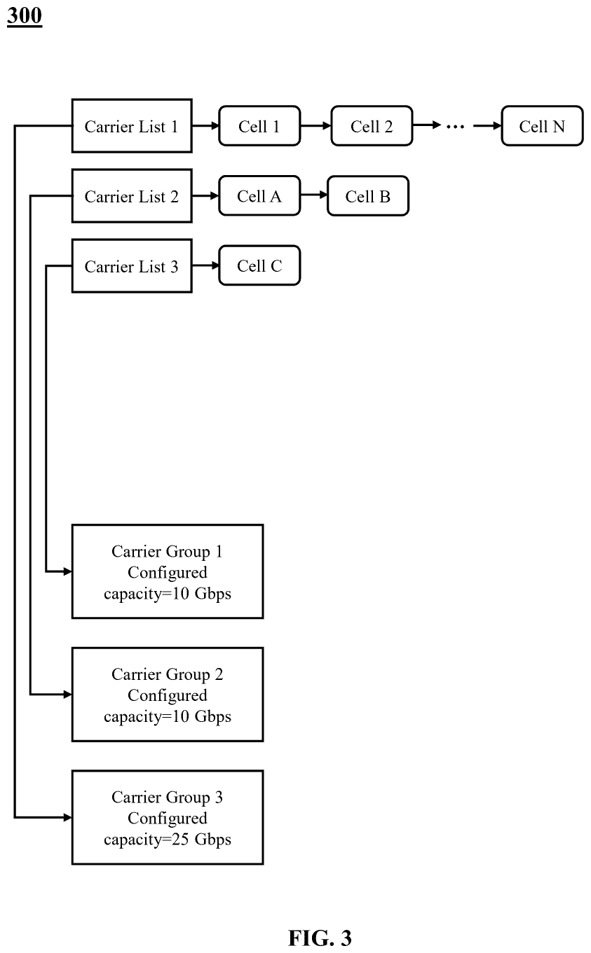

FIG. 3 illustrates the mapping of one or more carriers to shared fronthaul link capacity, in accordance with an embodiment of the present disclosure.

FIG. 3 illustrates a method for mapping (or associating) the one or more carriers to the shared fronthaul link capacity. The one or more carriers are configured to form a carrier group based on the shared fronthaul link capacity.

As already illustrated in FIG. 2A-2C, each of the O-RU (interchangeably referred to as “RU” herein) 116 supports one or more carriers or cells in the network. Further, there is an absence of a method to discover and identify the carriers and/or RUs 116 sharing the same fronthaul link towards a cell site. Therefore, the information related to the association of the one or more carriers to a shared fronthaul link is required to be configured in the DU 114. The information related to the association of the one or more carriers is identified and configured in the DU 114 based on the planning data for the cell sites.

As illustrated in FIG. 3, carrier list 1, carrier list 2, and carrier list 3 correspond to a list of carrier lists. Further, each carrier list is associated with a corresponding list of carriers, a corresponding base station identifier (ID), and a corresponding Distributed Unit (DU) ID. For example, the carrier list 1 includes N cells (or carriers) depicted as cell 1, cell 2 . . . , and cell N. Here, cell 1, cell 2 . . . , and cell N are the cell identifiers (IDs). In an example, the cell IDs may correspond to the New Radio (NR) cell local ID or the Evolved Universal Terrestrial Access (EUTRA) cell local ID. Further, each carrier or cell is associated with a corresponding base station identifier (ID) (e.g., gNodeB (gNB) ID or eNodeB (eNB) ID), and a corresponding DU ID.

FIG. 3 further illustrates a list of carrier groups depicted as carrier group 1, carrier group 2, and carrier group 3. Each carrier group in the list of carrier groups is configured with a shared fronthaul link capacity. For example, the carrier group 1 is configured with a shared fronthaul link capacity of 10 Gbps.

The shared fronthaul link capacity is configured based on the capacity of a link with least capacity between the DU 114 and a RU 116 at a cell site. For example, based on the topology in FIG. 2C, consider the links between the physical port Fronthaul PF 0 of the DU 114 and RUs 116 at site-1. Further, consider link-A is the least capacity link between the DU 114 and the site-1 with a capacity of 10 Gbps. In the example, the carrier group associated with site-1 will have the shared fronthaul link capacity configured as 10 Gbps. It is important to note that the shared fronthaul link capacity in the example is different from the capacity of the physical port (e.g. Fronthaul PF 0) of the DU 114.

Furthermore, each of the carrier lists may be configured to be mapped or associated with the corresponding carrier group. As illustrated in FIG. 3, the carrier list 1 is configured to be mapped to the carrier group 1. Similarly, the carrier list 2 is configured to be mapped to the carrier group 2. The carrier list 3 is configured to be mapped to the carrier group 3.

The mapping is performed based on the planning data for the cell sites. The mapping helps configure and determine the shared fronthaul link capacity for the carriers (or cells) in the carrier list. The configuration of the list of carrier lists and the list of carrier groups is configured in the DU 114. FIG. 3 illustrates a single DU 114 for the sake of clarity, and the configuration associated with each carrier list and corresponding carrier group is configured in each of the one or more DUs. The shared fronthaul link capacity corresponding to each carrier group is also configured in each of the one or more DUs.

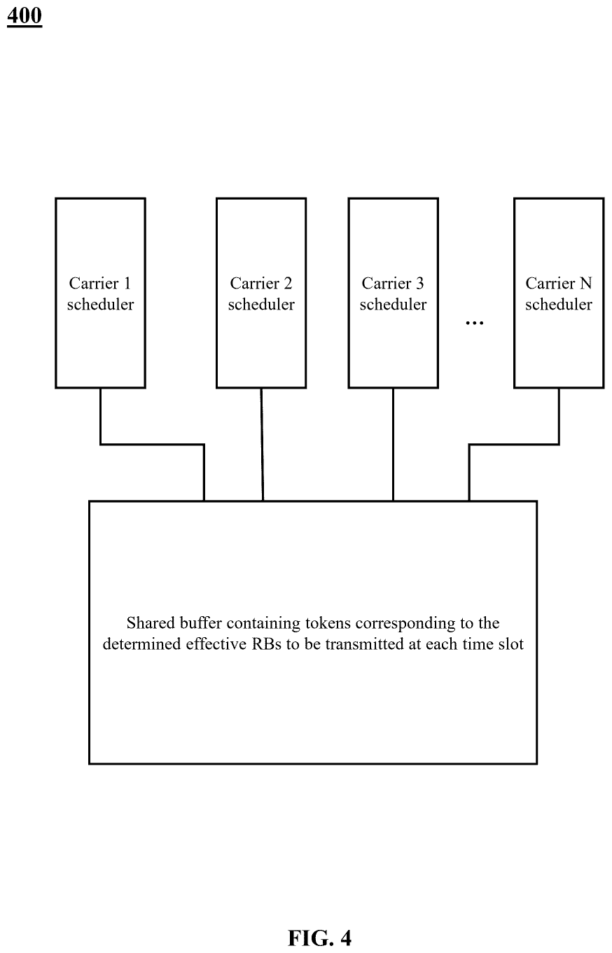

FIG. 4 illustrates scheduling the transmission of data packets for one or more carriers via a shared buffer, in accordance with an embodiment of the present disclosure.

FIG. 4 is associated with a method for limiting scheduled resources for a carrier group based on the shared fronthaul link capacity. The one or more carriers associated with the carrier group sharing the fronthaul link are handled by one or more DUs. In an example, the method and corresponding steps explained in FIG. 4 are performed after the list of carrier lists and the mapping to the carrier groups is configured in each of the one or more DUs. The mapping of the one or more carriers in a carrier list to a carrier group has already been explained in FIG. 3.

Based on the identification of the one or more carriers mapped (or associated) with a carrier group, the present disclosure ensures coordination between the one or more DUs involved in scheduling the transmission of data packets for the carrier group. The scheduling of the transmission of data packets is performed to ensure that the scheduled transmission does not exceed the shared fronthaul link capacity for the carrier group.

In an example scenario of the present disclosure, the list of carriers that are associated with a carrier group (i.e. shared fronthaul link capacity) may be spread across one or more DUs. In the example, the corresponding DU ID for the cells (or carriers) illustrated in FIG. 3 may be different. The cell 1 of the carrier list 1 may be associated with a DU 1 and the cell 2 may be associated with a DU 2, and similarly for other cells in the carrier list 1. Therefore, the present disclosure requires coordination among the one or more DUs associated with a carrier group.

In an embodiment of the present disclosure, a DU 114 from among the one or more DUs may perform the functions and steps of the apparatus 114 in the present disclosure. In the embodiment, the apparatus is configured to identify the leader DU. The leader DU handles the coordination among the one or more DUs.

In an example, consider that the one or more DUs correspond to N number of DUs. Let the one or more DUs have initial IDs as DU 1, DU 2, . . . and DU N. Usually, in a non-limiting embodiment, the number of DUs across which the carriers belonging to a cell site are spread may be 2. The present disclosure further requires sidehaul links among the one or more DUs.

The characteristics associated with the sidehaul links may include low latency and high bandwidth. In the example, the sidehaul link may correspond to the already supported sidehaul link for use cases like inter-DU carrier aggregation (CA), inter-DU Coordinated Multipoint (CoMP), and the like.

Further, the apparatus 114 is configured to obtain a number of Physical Resource Blocks (PRBs) corresponding to each of one or more DUs. The apparatus 114 may be configured to exchange information among each of the one or more DUs to obtain the number of corresponding PRBs. The exchanged information may include the DU ID for each of the one or more DUs, a list of carrier groups associated with each of the one or more DUs, and the number of PRBs handled by each of the one or more DUs. In an example, the exchanged information may be exchanged among the one or more DUs using the sidehaul link.

For example, consider 6 carriers are associated with carrier aggregation for a carrier group. Further, the carriers are assigned IDs as cell 1 to cell 6. Each of the 6 carriers is associated with 100 PRBs and shares a fronthaul link capacity of 10 Gbps. The cell 1 to cell 3 are associated with a DU with DU ID as DU 1. The cell 4 to cell 6 are associated with a DU with DU ID as DU 2. Therefore, in the example, DU 1 handle 300 PRBs and DU 2 handle 300 PRBs.

The exchanged information will include the number of PRBs handled by DU 1 as 300 PRBs and DU 2 as 300 PRBs. The example provided is non-limiting and the skewed distribution of PRBs among the one or more DUs is also supported by the present disclosure (e.g. 400 PRBs handled by DU 1 and 200 PRBs handled by DU 2).

In the embodiment, leader DU is identified as a DU 114 associated with the maximum obtained number of PRBs from among the one or more DUs. The apparatus 114 may further assign a corresponding sequence identifier (ID) to each of the one or more DUs based on the obtained number of PRBs. Further, each of the one or more DUs is switched as the leader DU successively at a predetermined time interval based on the assigned corresponding sequence ID.

In an example, the apparatus 114 exchanges information with each of the one or more DUs. In the exchanged information, the apparatus 114 may obtain the number of PRBs handled by each of the one or more DUs. The apparatus 114 identifies the leader DU as the DU 114 handling the maximum number of PRBs. The leader DU is assigned the first sequence ID (e.g. DU 1) as the leader DU handles the maximum number of PRBs. Further, the leader DU is assigned the highest priority in the transmission of the data packets associated with the carrier group.

Further, a DU handling the second highest number of PRBs is assigned a second sequence ID (e.g. DU 2). Similarly, the other DUs among the one or more DUs are assigned sequence identifiers (IDs) based on the number of PRBs handled by each DU 114. The purpose of assigning sequence identifiers is to ensure that each of the one or more DUs is provided with an opportunity to be assigned as the leader DU.

Further, in the example, the DU 114 handling the maximum number of PRBs and with assigned first sequence ID assumes the role of leader DU for a predetermined time interval. The predetermined interval is configured as a multiple of a Transmission Time Interval (TTI) or a time slot. In the example, the predetermined time interval may correspond to 10 time slots. The DU with assigned first sequence ID (DU 1) assumes the role of leader DU for time slots 1 to 10. The DU with assigned second sequence ID (DU 2) switches to the role of leader DU for time slots 11 to 20. Similarly, the leader DU may be switched after the predetermined interval based on the assigned sequence ID for the one or more DUs. In the example, on switching of the leader DU the sequence IDs may be re-assigned for each of the one or more DUs. The leader DU after the switching is assigned the first sequence ID, and the sequence IDs of the other DUs are re-assigned accordingly.

In an embodiment, a corresponding shared buffer is implemented identically at each of the one or more DUs, wherein the corresponding shared buffer is configured to store tokens associated with the data transmission for the carrier group.

The shared buffer depicted in FIG. 4 is implemented identically at the one or more DUs. Carrier schedulers associated with each of the one or more carriers in the carrier group are present at each of the one or more DUs. As illustrated in FIG. 4, the carrier schedulers corresponding to each of the one or more carriers (e.g. N carriers) are present at each of the one or more DUs. For example, the carrier 1 scheduler is responsible for scheduling the transmission for the first carrier (e.g. cell 1) in the carrier group. The carrier 2 scheduler is responsible for scheduling the transmission for the second carrier (e.g. cell 2) in the carrier group. Similarly, the carrier N scheduler is responsible for scheduling the transmission for the Nth carrier (e.g. cell N) in the carrier group.

At each DU 114 from among the one or more DUs, the shared buffer along with the carrier schedulers uses the token bucket algorithm. The shared buffer includes the tokens equal to the number of effective resource blocks (RBs) (Eσᵢ) to be scheduled by the DU 114. The leader DU assigns the tokens to be handled by each DU among the one or more DUs. The detailed methodology of assigning tokens by the leader DU is described in the following paragraphs.

Each of the one or more DUs is configured with the configuration of carriers in carrier groups as illustrated in FIG. 3. The configuration as depicted in FIG. 3 is provided to each of the one or more DUs to enable the one or more DUs to associate the one or more carriers in a carrier group. The configuration as depicted in FIG. 3 also helps each of the one or more DUs to identify the configured shared fronthaul link capacity for the carrier group.

Each DU 114 may then obtain the number of PRBs handled by each of the one or more DUs using the sidehaul link. The one or more DUs may compute the total number of PRBs (or aggregate PRBs) for the carrier group. The aggregate PRBs are computed by adding the number of PRBs for the carrier group handled by each of the one or more DUs. Each of the one or more DUs may then compute the effective RBs (Eσᵢ) for the carrier group independently. The effective RBs correspond to the data packets to be transmitted for the carrier group. The computation of the effective RBs is performed based on the total number of PRBs for the carrier group and the configured shared fronthaul link capacity for the carrier group.

In an embodiment, a DU 114 from among the one or more DUs handling the maximum number of PRBs is identified as the leader DU. A shared buffer as illustrated in FIG. 4 is implemented identically at each of the one or more DUs. At time T₀, the shared buffer in the leader DU is filled with tokens equal to the effective RBs (Eσᵢ) for the carrier group. The carrier schedulers in the leader DU (e.g. DU 1) are assigned the number of tokens based on the data packets to be scheduled for transmission by the leader DU. The remaining tokens are transferred to a DU 114 with the next sequence ID (e.g. DU 2). The carrier schedulers of the DU 2 are assigned the number of tokens based on the data packets to be scheduled for transmission by the DU 2. The process is repeated for the one or more DUs based on the assigned sequence IDs and till the tokens have been assigned (or tokens remaining are equal to zero) to carrier schedulers in each of the one or more DUs. Further, the process of computation of effective RBs and assignment of tokens among the corresponding carrier schedulers of the one or more DUs is repeated at each TTI or time slot.

The method of token assignment among the carrier schedulers in each of the one or more DUs may be provided as:

```
For each carrier group CGᵢ:
  Next_Leader_DU[CGᵢ] = DU with highest aggregate PRB for that CGᵢ
  Available_Tokens = Eσᵢ
  While (Available_Tokens !=0 AND Next_Leader_DU[CGᵢ] NOT EMPTY):
    Fill Available_Tokens tokens in the shared buffer of Next_Leader_DU[CGᵢ]
    Carriers in Next_Leader_DU[CGᵢ] grab tokens
    //Grabbed_Tokens decrement happens when each carrier grab tokens and this happens
as an atomic decrement
    Available_Tokens = Available_Tokens − Grabbed_Tokens
    Next_Leader_DU[CGᵢ] = DU with next highest aggregate PRB for that CGᵢ
    If (Next_Leader_DU[CGᵢ] NOT EMPTY):
      Pass Available_Tokens to Next_Leader_DU[CGᵢ]
  End While
End For Each
```

The scheduling of the transmission of data packets for a carrier group (e.g. for carrier group 1 of FIG. 3) is bounded by strict timing requirements per TTI. Therefore, the sidehaul link is configured to have a low latency and high bandwidth. The process of assignment of tokens among the corresponding carrier schedulers of the one or more DUs is required to be completed within almost the first 60 μsec of each TTI (or less than 1 symbol duration).

In some embodiments, the present disclosure further provides a run-time leader selection mechanism. The run-time leader selection may be required for scenarios where the non-leader DU may be a preferred DU. In an example, the non-leader DU may be the preferred DU due to assigned preference in network operator policy. The non-leader DU may be handling the PRBs associated with a few carriers. Therefore, the PRBs handled by the non-leader are also lesser and may not be selected as leader DU based on the already disclosed method of leader DU identification.

Nevertheless, as the non-leader is a preferred DU, the preferred DU may be preferred by the User Equipments (UEs) for anchoring or registration. This may lead to higher Buffer Occupancy (BO) at the preferred (non-leader) DU.

In another example, the Supplementary Downlink (SDL) carriers are preferred for downlink-intensive operations. The SDL carriers are therefore added as the preferred Secondary Cells (SCells) in Carrier Aggregation (CA). Further, in the CA the SDL Scells are associated with the maximum data from the Radio Link Control (RLC) buffers. In the scenarios as explained herein, having a preferred DU waiting for the assignment of tokens to transmit data packets may adversely affect the network performance. The present disclosure therefore provides a run-time leader selection mechanism.

In an embodiment, the apparatus is configured to perform a run-time leader selection mechanism based on a comparison of average Buffer Occupancy (BO) associated with each of the one or more DUs with a predefined threshold. In the embodiment, the apparatus is configured to determine the average BO associated with each of the one or more DUs based on a predefined time slot.

The method for the run-time leader selection algorithm may be provided as:

```
For each carrier group CGᵢ:
  For each DUₓ in CGᵢ:
    For each carrier j associated with DU in CGᵢ:
      avg_bo_carrier[j] = 0
      For each TTI:
        avg_bo_carrier[j] = (avg_bo_carrier[j] +
        current_bo[j])/averaging_window_size
    avg_bo_du = Σⱼ₌₀ⁿ avg_bo_carrier[j]
    if (avg_bo_du > threshold) signals all DU in the group that DUₓ is
    the leader DU
```

The above algorithm uses a running average. The predefined slot may correspond to the averaging window size. The averaging window size and the predefined threshold are configurable. The average window size and the predefined threshold are configured with identical values across all DUs in a carrier group (e.g. CGi). The mechanism enables the selection of the leader DU based on the average buffer occupancy (BO).

As used herein, the Buffer Occupancy (BO) refers to the amount of data stored in the Radio Link Control (RLC) buffer at a given time in a DU (among the one or more DUs). The BO may be expressed as a percentage or an absolute value, relative to the RLC buffer's total capacity.

The preferred DU on selection as leader DU is assigned the highest priority (in the next TTI) in the transmission of data packets associated with the carrier group. The mechanism may further be followed by switching of leader DU among the one or more DUs based on the assigned sequence IDs, as already explained in the present disclosure.

In an example, consider a DU with ID as DU 1 is the leader DU, and a second DU is assigned a sequence ID as DU 2, followed by a third DU assigned a sequence ID as DU 3.

Further, the DU 2 may observe a high average BO as a preferred DU. The DU 2 may signal to the DU 1 and DU 3 exchanging the high BO observed at DU 2. A request may be made by DU 2 for a run-time leader selection based on the average BO and the predefined threshold.

Thereafter, DU 2 may become the leader DU and is re-assigned as DU 1. Further, the previous leader DU may be assigned the sequence ID as DU 2. The sequence ID for the DU 3 may remain unchanged in the example.

In some embodiments, the apparatus 114 is configured to detect a disconnect or a failure in at least one DU from among the one or more DUs. Further, the apparatus 114 is configured to remove the at least one DU from the one or more DUs associated with carrier aggregation for the carrier group. The apparatus 114 is further configured to re-assign the corresponding sequence identifier (ID) to each of the one or more DUs, when the at least one DU corresponds to the leader DU.

The present disclosure enables the handling of detected disconnect or failure in at least one DU among the one or more DUs. Further, the at least one DU with detected disconnect is removed from the one or more DUs associated with carrier aggregation for the carrier group.

In an example, consider that one or more DUs are assigned sequence IDs as DU 1, DU 2, and DU 3. A disconnect or disconnect in a DU (e.g. DU 2) may be detected when a DU is taken out of service or when a DU fails for any reason (e.g., hardware failures, software failures, and the like). Further, the sidehaul links of the DU (e.g. DU 2) established with other DUs are terminated. The embodiment may further include re-assigning the sequence IDs to the one or more DUs. In the example, the DU 2 is removed from the DUs transmitting data packets associated with the carrier group. The DU 1 remains the leader DU, and DU 3 may be re-assigned the sequence ID as DU 2.

The method for re-assigning the sequence IDs to each of the one or more DUs may be provided as:

```
Let DUᵢ sequence in the sequence ID be Seqᵢ.
NOTE: DU leadership sequencing is in increasing order. Leader DU has
Seq 0, the next DU has Seq 1 and so on.
If sidehaul link to DUᵢ is terminated:
  If DUᵢ was not the leader DU before (i.e Seqᵢ ≠ 0):
    The DUᵢ₋₁ with Seqᵢ₋₁ starts forwarding the residue tokens to DUᵢ₊₁
that has Seqᵢ₊₁ skipping DUᵢ
  Else
    The DUᵢ₊₁ that has Seq₀ becomes leader DU and the sequences of
subsequent DUs get reduced by 1.
```

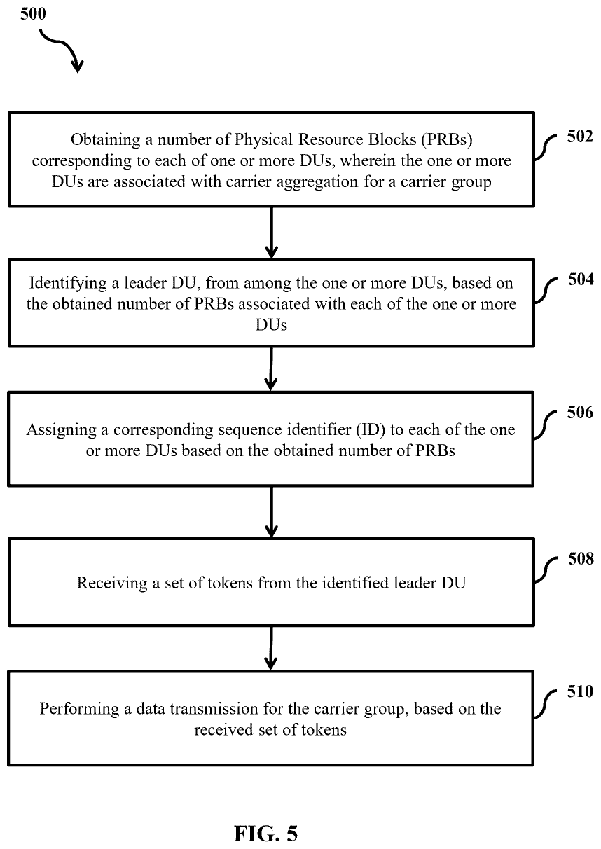

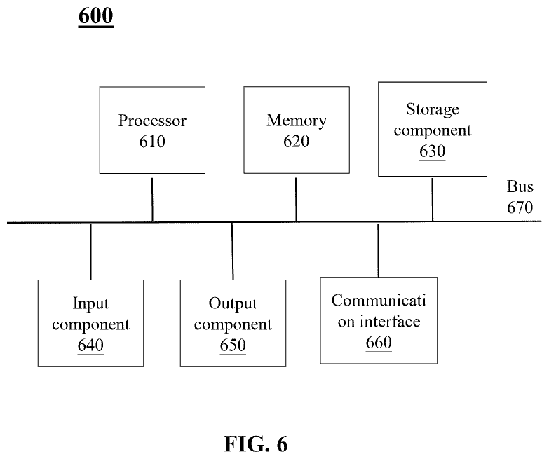

FIG. 5 illustrates a process flow depicting a method 500 for implementing radio resource scheduling for a carrier group by one or more DUs, in accordance with an embodiment of the present disclosure.

At step 502, the method 500 includes obtaining a number of Physical Resource Blocks (PRBs) corresponding to each of one or more DUs. The one or more DUs are associated with carrier aggregation for a carrier group.

In an embodiment of the present disclosure, the method 500 comprises exchanging information among each of the one or more DUs. Further, the exchanged information comprises DU ID for each of the one or more DUs, a list of carrier groups associated with each of the one or more DUs, and the number of PRBs handled by each of the one or more DUs.

At step 504, the method 500 includes identifying a leader DU, from among the one or more DUs. The leader DU is identified based on the obtained number of PRBs associated with each of the one or more DUs.

In an embodiment of the present disclosure, the method 500 comprises identifying the leader DU as a DU associated with the maximum obtained number of PRBs from among the one or more DUs.

At step 506, the method 500 includes assigning a corresponding sequence identifier (ID) to each of the one or more DUs based on the obtained number of PRBs.

In an embodiment of the present disclosure, wherein each of the one or more DUs are switched as the leader DU successively at a predetermined time interval based on the assigned corresponding sequence ID.

At step 508, the method 500 includes receiving a set of tokens from the identified leader DU.

In an embodiment of the present disclosure, a corresponding shared buffer is implemented identically at each of the one or more DUs. Further, the corresponding shared buffer is configured to store tokens associated with the data transmission for the carrier group.

At step 510, the method 500 includes performing a data transmission for the carrier group, based on the received set of tokens.

In some embodiments of the present disclosure, the method 500 comprises performing a run-time leader selection mechanism based on a comparison of average Buffer Occupancy (BO) associated with each of the one or more DUs with a predefined threshold. The method 500 comprises determining the average BO associated with each of the one or more DUs based on a predefined time slot.

In some embodiments of the present disclosure, the method 500 includes detecting a disconnect or a failure in at least one DU from among the one or more DUs. The method 500 further includes removing the at least one DU from the one or more DUs associated with carrier aggregation for the carrier group. In the embodiment, the method 500 further includes re-assigning the corresponding sequence identifier (ID) to each of the one or more DUs. The re-assignment of the corresponding sequence ID may be performed when the at least one DU corresponds to the leader DU.

The steps of the method 500 flow and the embodiments of the disclosure have been explained with the description for FIGS. 2A-2C, FIG. 3, and FIG. 4 of the present disclosure. The description has not been repeated for the sake of brevity.

While the above-discussed steps in FIG. 5 are shown and described in a particular sequence, the steps may occur in variations to the sequence in accordance with various exemplary embodiments.

The implementation of the present disclosure ensures statistical multiplexing based on the shared fronthaul link capacity. The implementation of the present disclosure is further associated with efficient utilization of shared fronthaul link capacity. Further, the present disclosure helps in avoiding Hybrid Automatic Repeat Request (HARQ) or Automatic Repeat Request (ARQ) retransmission due to dropped data packets. The data packets are usually dropped when scheduled data packets exceed the shared fronthaul link capacity. The efficient scheduling in accordance with the present disclosure ensures that the scheduled data packets do not exceed the shared fronthaul link capacity. Therefore, the present disclosure avoids HARQ and ARQ retransmissions.

Further, the present disclosure also describes non-transitory computer program products (i.e., physically embodied computer program products) or non-transitory computer-readable mediums encoded with executable instructions that store instructions. The executable instructions, when executed by one or more processors cause the one or more processors to perform as the methods described in the present disclosure, as elaborated in the preceding paragraphs. Examples of computer-readable mediums include non-volatile, hard-coded type mediums such as read-only memories (ROMs) or erasable, electrically programmable read-only memories (EEPROMs), and user-recordable type mediums such as floppy disks, hard disk drives and compact disk read-only memories (CD-ROMs) or digital versatile disks (DVDs).

FIG. 6 illustrates an embodiment of a device 600 associated with apparatus or the DU 114. As shown in FIG. 6, the device 600 includes a processor 610, a memory 620, a storage component 630, an input component 640, an output component 650, a communication interface 660, and a bus 670.

The processor 610, as used herein, means any type of computational circuit that may comprise hardware elements and software elements. The processor 610 may be embodied as a multi-core processor, a single-core processor, or a combination of one or more multi-core processors and/or one or more single-core processors, a distributed processing system, or the like. The processor 610 may be a Central Processing Unit (CPU), a graphics processing unit (GPU), an accelerated processing unit (APU), an application-specific integrated circuit (ASIC), or another type of processing component.

The memory 620 includes a non-transitory computer-readable medium. The memory 620 includes a random-access memory (RAM), a read-only memory (ROM), and/or another type of dynamic or static storage device (e.g., a flash memory, a magnetic memory, and/or an optical memory) that stores information and/or instructions for use by the processor 610. The memory 620 comprises machine-readable instructions which are executable by the processor 610. These machine-readable instructions when executed by the processor 610 cause the processor 610 to perform one or more method 500 steps of an example embodiment described in the present disclosure.

The storage component 630 stores information and/or software related to the operation and use of the device 600. For example, the storage component 630 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

The input component 640 is configured to receive information, such as user input. For example, the input component 640 may include, but not be limited to, a touchscreen display, a keyboard, a keypad, a mouse, a button, a switch, and/or a microphone. Additionally, or alternatively, the input component 640 may include a sensor for sensing information (e.g., a global positioning system (GPS), an accelerometer, a gyroscope, and/or an actuator).

The output component 650 is configured to provide output information from the device 600. For example, the output component 650 may be, but not limited to, a display, a speaker, instructions to an external device, and/or one or more light-emitting diodes (LEDs).

The communication interface 660 is an interface that provides a communication connection to other devices, such as external devices and internal devices. The connection by the communication interface 660 can be a wired connection, a wireless connection, or a combination of wired and wireless connections, and can be a direct connection or an indirect connection via a communication network that exists between the device 600 and other devices.

In other words, the standard of the communication interface 660 is not limited.

The bus 670 acts as an interconnect between the processor 610, the memory 620, the storage component 630, the input component 640, the output component 650, and the communication interface 660 of the device 600. The bus 670 may include a wired interconnection or a wireless interconnection.

The number and arrangement of components shown in FIG. 6 are provided as an example. In practice, the device 600 may include additional components, fewer components, different components, or differently arranged components than those shown in FIG. 6.

Additionally, or alternatively, a set of components (e.g., one or more components) of the device 600 may perform one or more functions described as being performed by another set of components of the device 600. Further, one or more method 500 steps described in any of the exemplary embodiments may be performed utilizing a plurality of devices 600 in communication with one another.

An apparatus configured to obtain a number of Physical Resource Blocks (PRBs) corresponding to each of one or more DUs. The one or more DUs are associated with carrier aggregation for a carrier group. The apparatus is further configured to identify a leader DU, from among the one or more DUs. The leader DU is identified based on the obtained number of PRBs associated with each of the one or more DUs. The apparatus is further configured to assign a corresponding sequence identifier (ID) to each of the one or more DUs based on the obtained number of PRBs. The apparatus is further configured to receive a set of tokens from the identified leader DU. The apparatus is furthermore configured to perform a data transmission for the carrier group based on the received set of tokens.

The apparatus as described in [00110], wherein the apparatus is configured to identify the leader DU as a DU associated with the maximum obtained number of PRBs from among the one or more DUs.

The apparatus as described in any of [00110] to [00111], wherein each of the one or more DUs are switched as the leader DU successively at a predetermined time interval. Each of the one or more DUs is switched as the leader DU based on the assigned corresponding sequence ID.

The apparatus as described in any of [00110] to [00112], wherein a corresponding shared buffer is implemented identically at each of the one or more DU. Further, the corresponding shared buffer is configured to store tokens associated with the data transmission for the carrier group.

The apparatus as described in any of [00110] to [00113], wherein the apparatus is configured to exchange information among each of the one or more DUs. Further, the exchanged information comprises the DU ID for each of the one or more DUs, a list of carrier groups associated with each of the one or more DUs, and the number of PRBs handled by each of the one or more DUs.

The apparatus as described in any of [00110] to [00114], wherein the apparatus is configured to perform a run-time leader selection mechanism. The run-time leader selection is based on a comparison of average Buffer Occupancy (BO) associated with each of the one or more DUs with a predefined threshold.

The apparatus as described in any of [00110] to [00115], wherein the apparatus is configured to determine the average BO associated with each of the one or more DUs based on a predefined time slot.

The apparatus as described in any of [00110] to [00116], wherein the apparatus is configured to detect a disconnect or a failure in at least one DU from among the one or more DUs. The apparatus is further configured to remove the at least one DU from the one or more DUs associated with carrier aggregation for the carrier group.

The apparatus as described in any of [00110] to [00117], wherein the apparatus is further configured to re-assign the corresponding sequence identifier (ID) to each of the one or more DUs. The re-assignment is performed when the at least one DU corresponds to the leader DU.

The apparatus as described in any of [00110] to [00118], wherein the apparatus corresponds to a DU, from among the one or more DUs, in a communication network.

A method comprises obtaining a number of Physical Resource Blocks (PRBs) corresponding to each of one or more DUs. The one or more DUs are associated with carrier aggregation for a carrier group. The method further comprises identifying a leader DU, from among the one or more DUs. The leader DU is identified based on the obtained number of PRBs associated with each of the one or more DUs. The method further comprises assigning a corresponding sequence identifier (ID) to each of the one or more DUs based on the obtained number of PRBs. The method further comprises receiving a set of tokens from the identified leader DU. The method furthermore comprises performing a data transmission for the carrier group, based on the received set of tokens.

The method as described in [00120], wherein the method comprises identifying the leader DU as a DU associated with maximum obtained number of PRBs from among the one or more DUs.

The method as described in any of [00120] to [00121], wherein each of the one or more DUs are switched as the leader DU successively at a predetermined time interval. Each of the one or more DUs is switched as the leader DU based on the assigned corresponding sequence ID.

The method as described in any of [00120] to [00122], wherein a corresponding shared buffer is implemented identically at each of the one or more DUs. Further, the corresponding shared buffer is configured to store tokens associated with the data transmission for the carrier group.

The method as described in any of [00120] to [00123], wherein the method comprises exchanging information among each of the one or more DUs. Further, the exchanged information comprises the DU ID for each of the one or more DUs, a list of carrier groups associated with each of the one or more DUs, and the number of PRBs handled by each of the one or more DUs.

The method as described in any of [00120] to [00124], wherein the method comprises performing a run-time leader selection mechanism. The run-time leader selection is based on a comparison of the average Buffer Occupancy (BO) associated with each of the one or more DUs with a predefined threshold.

The method as described in any of [00120] to [00125], wherein the method comprises determining the average BO associated with each of the one or more DUs based on a predefined time slot.

The method as described in any of [00120] to [00126], wherein the method includes detecting a disconnect or a failure in at least one DU from among the one or more DUs. The method further comprises removing the at least one DU from the one or more DUs associated with carrier aggregation for the carrier group.

The method as described in any of [00120] to [00127], wherein the method further comprises re-assigning the corresponding sequence identifier (ID) to each of the one or more DUs. The re-assignment is performed when the at least one DU corresponds to the leader DU.

A non-transitory computer-readable medium storing instructions. The instructions comprising one or more instructions that are executed by a Distributed Unit (DU) in the network. The DU comprises one or more processors. The one or more instructions cause the one or more processors to obtain a number of Physical Resource Blocks (PRBs) corresponding to each of one or more DUs. The one or more DUs are associated with carrier aggregation for a carrier group. Further, the instructions when executed cause the processor to identify a leader DU, from among the one or more DUs. The leader DU is identified based on the obtained number of PRBs associated with each of the one or more DUs. Further, the instructions when executed cause the processor to assign a corresponding sequence identifier (ID) to each of the one or more DUs based on the obtained number of PRBs. Further, the instructions when executed cause the processor to receive a set of tokens from the identified leader DU.

Furthermore, the instructions when executed cause the processor to perform a data transmission for the carrier group, based on the received set of tokens.

The embodiments disclosed herein can be implemented through at least one software program running on at least one hardware device and performing network management functions to control the elements. The elements can be at least one of a hardware device, or a combination of hardware devices and software modules.

It is understood that terms including “unit” or “module” at the end may refer to the unit for processing at least one function or operation and may be implemented in hardware, software, or a combination of hardware and software.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

We claim:

1. An apparatus configured to:
obtain a number of Physical Resource Blocks (PRBs) corresponding to each of one or more DUs, wherein the one or more DUs are associated with carrier aggregation for a carrier group;
identify a leader DU, from among the one or more DUs, based on the obtained number of PRBs associated with each of the one or more DUs;
assign a corresponding sequence identifier (ID) to each of the one or more DUs based on the obtained number of PRBs;
receive a set of tokens from the identified leader DU; and
perform a data transmission for the carrier group, based on the received set of tokens.

2. The apparatus of claim 1, wherein to identify the leader DU, the apparatus is configured to identify the leader DU as a DU associated with maximum obtained number of PRBs from among the one or more DUs.

3. The apparatus of claim 2, wherein each of the one or more DUs is switched as the leader DU successively at a predetermined time interval based on the assigned corresponding sequence ID.

4. The apparatus of claim 1, wherein a corresponding shared buffer is implemented identically at each of the one or more DUs, wherein the corresponding shared buffer is configured to store tokens associated with the data transmission for the carrier group.

5. The apparatus of claim 1, wherein to obtain the number of PRBs, the apparatus is configured to exchange information among each of the one or more DUs, and further wherein the exchanged information comprises a DU ID for each of the one or more DUs, a list of carrier groups associated with each of the one or more DUs, and the number of PRBs handled by each of the one or more DUs.

6. The apparatus of claim 1, wherein the apparatus is configured to perform a run-time leader selection mechanism based on a comparison of average Buffer Occupancy (BO) associated with each of the one or more DUs with a predefined threshold.

7. The apparatus of claim 6, wherein the apparatus is configured to determine the average BO associated with each of the one or more DUs based on a predefined time slot.

8. The apparatus of claim 1, wherein the apparatus is configured to:
detect a disconnect or a failure in at least one DU from among the one or more DUs; and
remove the at least one DU from the one or more DUs associated with carrier aggregation for the carrier group.

9. The apparatus of claim 8, wherein the apparatus is further configured to re-assign the corresponding sequence identifier (ID) to each of the one or more DUs, when the at least one DU corresponds to the leader DU.

10. The apparatus of claim 1, wherein the apparatus corresponds to a DU, from among the one or more DUs, in a communication network.

11. A method comprising:
obtaining a number of Physical Resource Blocks (PRBs) corresponding to each of one or more DUs, wherein the one or more DUs are associated with carrier aggregation for a carrier group;
identifying a leader DU, from among the one or more DUs, based on the obtained number of PRBs associated with each of the one or more DUs;
assigning a corresponding sequence identifier (ID) to each of the one or more DUs based on the obtained number of PRBs;
receiving a set of tokens from the identified leader DU; and
performing a data transmission for the carrier group, based on the received set of tokens.

12. The method of claim 11, wherein for identifying the leader DU, the method comprises identifying the leader DU as a DU associated with maximum obtained number of PRBs from among the one or more DUs.

13. The method of claim 12, wherein each of the one or more DUs is switched as the leader DU successively at a predetermined time interval based on the assigned corresponding sequence ID.

14. The method of claim 11, wherein a corresponding shared buffer is implemented identically at each of the one or more DUs, wherein the corresponding shared buffer is configured to store tokens associated with the data transmission for the carrier group.

15. The method of claim 11, wherein for obtaining the number of PRBs, the method comprises exchanging information among each of the one or more DUs, and further wherein the exchanged information comprises DU ID for each of the one or more DUs, a list of carrier groups associated with each of the one or more DUs, and the number of PRBs handled by each of the one or more DUs.

16. The method of claim 11, wherein the method comprises performing a run-time leader selection mechanism based on a comparison of average Buffer Occupancy (BO) associated with each of the one or more DUs with a predefined threshold.

17. The method of claim 16, wherein the method comprises determining the average BO associated with each of the one or more DUs based on a predefined time slot.

18. The method of claim 11, wherein the method comprises:
detecting a disconnect or a failure in at least one DU from among the one or more DUs; and
removing the at least one DU from the one or more DUs associated with carrier aggregation for the carrier group.

19. The method of claim 18, wherein the method further comprises re-assigning the corresponding sequence identifier (ID) to each of the one or more DUs, when the at least one DU corresponds to the leader DU.

20. A non-transitory computer-readable medium storing instructions, the instructions comprising: one or more instructions that, when executed by a Distributed Unit (DU) comprising one or more processors, cause the one or more processors to:
obtain a number of Physical Resource Blocks (PRBs) corresponding to each of one or more DUs, wherein the one or more DUs are associated with carrier aggregation for a carrier group;
identify a leader DU, from among the one or more DUs, based on the obtained number of PRBs associated with each of the one or more DUs;
assign a corresponding sequence identifier (ID) to each of the one or more DUs based on the obtained number of PRBs;
receive a set of tokens from the identified leader DU; and
perform a data transmission for the carrier group, based on the received set of tokens.
